(19) United States
(12) Patent Application Publication
(10) Pub. No.: US 2026/0184001 A1
(43) Pub. Date: Jul. 2, 2026

(54) CONTINUOUS FIBER REINFORCED CO-EXTRUSION DIE, MOLDING LINE BODY AND FIBER REINFORCED FOAMED FLOOR

(71) Applicant: VMKON (GUANGDONG) INDUSTRIAL DEVELOPMENT CO., LTD., GUANGZHOU (CN)

(72) Inventors: RUIHAO LI, GUANGZHOU (CN); QIU SUN, GUANGZHOU (CN); CAI SUN, GUANGZHOU (CN)

(21) Appl. No.: 19/080,197

(22) Filed: Mar. 14, 2025

(30) Foreign Application Priority Data
Dec. 27, 2024 (CN) 202411948549.3

(51) Int. Cl. B29C 48/305; B29C 48/07; B29C 48/21; B29K 105/04; B29K 105/10; B29K 309/08; B29L 31/00; B32B 5/20

(52) U.S. Cl. CPC B29C 48/307; B29C 48/07; B29C 48/21; B32B 5/20; B29K 2105/04; B29K 2105/101; B29K 2309/08; B29L 2031/732; B32B 2250/03; B32B 2250/40; B32B 2262/101; B32B 2471/00

(57) ABSTRACT

A continuous fiber reinforced co-extrusion die, a molding line body and a fiber reinforced foamed floor are provided. The die includes a die body, front and rear endfaces of which are respectively a mixing extrusion surface and a core material feeding surface. One side face of the die body has a shell material feeding inlet. The die body is provided thereinside with a core material supply channel penetrating through the mixing extrusion surface and the core material feeding surface; a shell material supply cavity surrounding the core material supply channel; and two arc-shaped curved fiber channels symmetrically arranged vertically respectively. The molding line body includes a continuous fiber reinforced co-extrusion die, a core material extruder and a shell material extruder; and a shaping module, a vacuum water cooling group, an open water cooling group and a traction machine are arranged on the mixing extrusion surface of the die body.

### CROSS REFERENCE TO RELATED APPLICATIONS

The present disclosure claims the priority to the Chinese patent application with the filing No. 202411948549.3, entitled “CONTINUOUS FIBER REINFORCED CO-EXTRUSION DIE, MOLDING LINE BODY AND FIBER REINFORCED FOAMED FLOOR” and filed on Dec. 27, 2024 with the Chinese Patent Office, the contents of which are incorporated in the present disclosure by reference in their entirety.

### TECHNICAL FIELD

The present disclosure relates to the technical field of sports floors or foamed floors, and more specifically to a continuous fiber reinforced co-extrusion die, a molding line body and a fiber reinforced foamed floor.

### BACKGROUND ART

In the field of plastic processing, extrusion molding is a widely used method for producing plastic profiles. However, the plastic extrusion dies in the prior art have some technical problems in the production process. For example, plastic profiles produced by traditional extrusion processes usually have problems of insufficient strength and rigidity, which limits the application of plastic profiles in fields with high requirements for mechanical properties.

For example, in the application field of outdoor floors, frequent pedestrian trampling, placement of outdoor furniture, thermal expansion and cold contraction caused by climate change, and erosion of materials by wind, sun and rain, etc., lead to shorten service life of the floor. Reinforcement fiber is a commonly used fibrous reinforcement material with the performance of reinforcing the plastic matrix. In the prior art, there already has been a continuous fiber reinforced extrusion die, which usually co-extrudes a middle material of a plate provided in a mainstream channel, a reinforcement material added in an interlayer channel and a material for producing an outer shell body to achieve molding, to enhance the strength of the plastic profile. However, for the existing continuous fiber reinforced extrusion die, during the processing, the plastic matrix and the reinforcement fiber are simply mixed and extruded, which cannot effectively guarantee the uniform distribution of the reinforcement fiber, resulting in that the reinforcement fiber and the plastic matrix cannot be synergistically forced well and the overall strength of the profile cannot be effectively improved.

Therefore, the problem to be urgently solved by a person skilled in the art is how to provide a co-extrusion die that can achieve uniform distribution of reinforcement fibers and improved overall strength.

### SUMMARY

In view of this, the present disclosure provides a continuous fiber reinforced co-extrusion die, a molding line body and a fiber reinforced foamed floor, aiming to solve the above technical problems.

In order to achieve the above object, the present disclosure adopts the following technical solutions.

A continuous fiber reinforced co-extrusion die includes a die body, where the front and rear end faces of the die body are respectively a mixing extrusion surface and a core material feeding surface, and one side face of the die body is provided with a shell material feeding inlet;
the die body is provided thereinside with a core material supply channel penetrating through the mixing extrusion surface and the core material feeding surface, and the core material supply channel penetrates through one end of the mixing extrusion surface to form a core material extrusion outlet;
the die body is provided thereinside with a shell material supply cavity surrounding the core material supply channel, one side of the shell material supply cavity communicates with the shell material feeding inlet, and the shell material supply cavity extends toward the mixing extrusion surface and penetrates through the mixing extrusion surface to form a shell material extrusion outlet; and
the die body is provided thereinside with two fiber channels, and the two fiber channels are symmetrically arranged up and down respectively, the fiber channels are each an arc-shaped curved channel, and each have both ends penetrating through the mixing extrusion surface, one ends of the two fiber channels are open to form fiber extrusion outlets, and are respectively located above and below the core material extrusion outlet and located on the inner side of the shell material extrusion outlet, the other ends of the two fiber channels are open to form fiber extrusion inlets, and the two fiber extrusion inlets are respectively located above and below the shell material extrusion outlet.

Through the above technical solution, the continuous fiber reinforced co-extrusion die provided by the present disclosure allows different materials (such as plastic matrix, reinforcement fibers, etc.) to remain separated from each other during the extrusion process until entering the subsequent shaping mold for compounding. This layered extrusion method can accurately control the distribution and content of each material, thereby optimizing the overall strength and performance of the composite material; the curved flow channel design of the fiber channel allows the reinforcement fibers to flow along a specific path during the conveying process, guides the reinforcement fibers to form a specific orientation during the extrusion process, and at the same time, improves, by utilizing the curving, the stability of the fiber input process and prevents moving thereof, thereby ensuring uniform distribution of the reinforcement fibers. Since the channels are independent, unnecessary mixing or interference of the reinforcement fibers with other materials (such as plastic matrix) during the conveying process can be avoided, thereby ensuring uniform distribution and orientation of the reinforcement fibers and improving overall strength and performance.

Preferably, in the above-mentioned continuous fiber reinforced co-extrusion die, the edge of the core material extrusion outlet extends in a direction away from the mixing extrusion surface to form a core material temperature control extension cylinder. By providing the core material temperature control extension cylinder, the core material and the shell material may be cooled in stages, thereby preventing the problem of internal stress concentration caused by simultaneous cooling.

Preferably, in the above-mentioned continuous fiber reinforced co-extrusion die, the outer side of the fiber extrusion inlet is provided with a clamping roller assembly installed on the mixing extrusion surface. The clamping roller assembly can improve the clamping stability of the fibers, play a role in precise guidance, and simultaneously reduce the friction between the fibers and the input inlet, so that the fiber can enter the channel more smoothly.

Preferably, in the above-mentioned continuous fiber reinforced co-extrusion die, the clamping roller assembly has a one-way rotation limiting structure. The one-way rotation limiting structure may prevent the clamping roller assembly from rotating reversely and has a precise guiding effect.

Preferably, in the above-mentioned continuous fiber reinforced co-extrusion die, the outer side of the clamping roller assembly is wrapped with a heater, and the heater has a fiber inlet. The heater may preheat the fibers and make the fusion effect of individual layers better.

Preferably, in the above-mentioned continuous fiber reinforced co-extrusion die, the inner wall of the fiber channel is coated with a Teflon coating. The coating of the Teflon coating material can reduce the friction between the fibers and the channel wall, help to smoothly convey the reinforcement fibers, reduce the fiber breakage and blockage of the reinforcement fibers, and improve production efficiency.

Preferably, in the above-mentioned continuous fiber reinforced co-extrusion die, the diameter of the core material supply channel gradually decreases in a direction from the core material feeding surface to the mixing extrusion surface. This structural setting can make the plastic matrix gradually compressed during the extrusion process to form a more compact structure.

Preferably, in the above-mentioned continuous fiber reinforced co-extrusion die, the curved portion of the arc-shaped curved channel is rounded, so that the fiber conveying path is smoother and the friction and damage of the reinforcement fiber during the conveying process are reduced.

The present disclosure further provides a molding line body, including the above-mentioned continuous fiber reinforced co-extrusion die, where the core material supply channel of the core material feeding surface of the die body is connected to a core material extruder, and the shell material feeding inlet of the die body is connected to a shell material extruder; and a shaping module, a vacuum water cooling group, an open water cooling group and a traction machine are sequentially arranged on the mixing extrusion surface of the die body.

Through the above technical solution, the present disclosure realizes the preparation of continuous fiber reinforced composite materials by extruding a plastic matrix to form an outer shell body and a core layer, and sending glass fibers to a shaping mold to be cooled together with the outer shell body and the core layer.

The present disclosure further provides a fiber reinforced foamed floor, including a floor body formed by processing by the above-mentioned molding line body, and the floor body is provided thereinside with two fiber reinforced layers arranged vertically.

Through the above technical solutions, the present disclosure adds reinforcement fibers to both the outer shell body and the inner core material during filling, where the reinforcement fibers can be arranged in a specific direction in the outer shell body, just like building a “skeleton” in the material, thereby improving the tensile and compressive resistance of the outer shell body; in the internal filling space, the reinforcement fibers cooperate with the core material to further enhance the strength and stability of the profile inside; and the synergistic effect of the high strength of the outer shell body and the internal fiber reinforcement enables the profile to withstand greater external forces, effectively solving the problem of insufficient strength of existing plastic profiles.

It can be seen from the above technical solutions that compared with the prior art, the present disclosure discloses a continuous fiber reinforced co-extrusion die, a molding line body and a fiber reinforced foamed floor, which have the following beneficial effects.
1. Enhancement of the mechanical properties of plastic profiles: by using the continuous fiber reinforced co-extrusion die and the molding line body, plastic profiles with uniform distribution of reinforcement fibers can be produced, thereby improving the overall strength and rigidity of the profiles, solving the problem of insufficient strength and rigidity of plastic profiles produced by traditional extrusion processes.
2. Increase of the service life of the floor: in the application of outdoor floors, due to the addition of reinforcement fibers, the floor can better withstand the trampling of pedestrians, the placement of outdoor furniture, thermal expansion and cold contraction caused by climate change, and erosion by wind, sun, rain, etc., thereby prolonging the service life of the floor.
3. Optimization of the overall performance of the composite material: through layered extrusion, the distribution and content of each material can be accurately controlled to optimize the overall performance of the composite material.
4. Uniform distribution and specific orientation of reinforcement fibers: the fiber channel with curved flow channel design can guide the reinforcement fibers to form a specific orientation during the extrusion process, ensuring uniform distribution of the reinforcement fibers and improving overall strength and performance.
5. Reduction of the problem of internal stress concentration: by providing a core material temperature control extension cylinder, the core material and the shell material can be cooled in stages to prevent the problem of internal stress concentration caused by simultaneous cooling.
6. Improvement of fiber clamping stability and reduction of friction: the clamping roller assembly can improve the fiber clamping stability, reduce the friction between the fibers and the input inlet, and allow the fibers to enter the channel more smoothly.
7. Precise guiding and preventing of reverse rotation: the one-way rotation limiting structure on the clamping roller assembly can prevent the clamping roller assembly from rotating reversely, enabling a precise guiding effect.
8. Improvement of the fusion effect of individual layers: the heater on the outer side of the clamping roller assembly can preheat the fibers to improve the fusion effect of individual layers.
9. Reduction of the friction between the fibers and the channel wall: the Teflon coating coated on the inner wall of the fiber channel can reduce the friction between the fibers and the channel wall, reduce the breakage and blockage of the reinforcement fibers, and improve production efficiency.
10. Forming of a compact structure: the diameter of the core material supply channel gradually decreases in a direction from the core material feeding surface to the mixing extrusion surface, so that the plastic matrix is gradually compressed during the extrusion process to form a more compact structure.
11. Reduction of friction and damage during fiber conveying: the curved portion of the arc-shaped curved channel is rounded to make the fiber conveying path smoother and reduce friction and damage to the reinforcement fibers during conveying.
12. Realizing of preparation of continuous fiber reinforced composite material: through the continuous operation of the molding line body, the efficient preparation of continuous fiber reinforced composite material is realized.
13. Improvement of the tensile and compressive resistance of the profile: the reinforcement fibers arranged in a specific direction in the outer shell body are like a “skeleton” built in the material, improving the tensile and compressive resistance of the outer shell body.
14. Enhancement of the strength and stability of the profile inside: in the internal filling space, the reinforcement fibers and the core material cooperate with each other to further enhance the strength and stability of the profile inside.

### BRIEF DESCRIPTION OF DRAWINGS

In order to more clearly illustrate the embodiments of the present disclosure or the technical solutions in the prior art, the drawings required for use in the embodiments or the description of the prior art will be briefly introduced below. Apparently, the drawings described below are only embodiments of the present disclosure. For a person having ordinary skill in the art, other drawings may be obtained based on the provided drawings without paying creative work.

FIG. 1 is a schematic view of the structure of a continuous fiber reinforced co-extrusion die provided by the present disclosure;

FIG. 2 is a cross-sectional view of the structure of a continuous fiber reinforced co-extrusion die provided by the present disclosure;

FIG. 3 is a cross-sectional view of a continuous fiber reinforced co-extrusion die provided by the present disclosure;

FIG. 4 is a schematic view of the structure of a clamping roller assembly provided by the present disclosure;

FIG. 5 is a schematic view of the structure of a heater provided by the present disclosure;

FIG. 6 is a schematic view of the structure of the molding line body provided by the present disclosure;

FIG. 7 is a schematic view of the structure of a shaping module provided by the present disclosure;

FIG. 8 is a schematic view of the structure of a vacuum water cooling group provided by the present disclosure;

FIG. 9 is a schematic view of the structure of an open water cooling group provided by the present disclosure;

FIG. 10 is a schematic view of the structure of a traction machine provided by the present disclosure; and

FIG. 11 is a schematic view of the structure of the fiber reinforced foamed floor provided by the present disclosure.

In the above:
1—core material extruder;
2—shell material extruder;
3—die body;

31—mixing extrusion surface; 311—core material extrusion outlet; 312—shell material extrusion outlet; 313—fiber extrusion outlet; 314—fiber extrusion inlet; 32—core material feeding surface; 33—core material supply channel; 34—shell material supply cavity; 35—fiber channel; 36—core material temperature control extension cylinder; 37—clamping roller assembly; 371—mounting plate; 372—clamping roller; 373—ratchet; 374—pawl; 38—heater; 381—fiber inlet;

4—shaping module;

41—shaping mold; 411—shaping cavity;

5—vacuum water cooling group;

51—guide frame;

6—open water cooling group;

61—air nozzle;

7—traction machine;

8—floor body;

81—fiber reinforced layer.

### DETAILED DESCRIPTION OF EMBODIMENTS

The technical solutions in embodiments of the present disclosure will be clearly and completely described in conjunction with drawings in the embodiments of the present disclosure. Apparently, the described embodiments are only some, but not all of the embodiments of the present disclosure. Based on the embodiments of the present disclosure, all other embodiments obtained by a person having ordinary skill in the art without creative work should fall within the scope of protection of the present disclosure.

### Embodiment 1

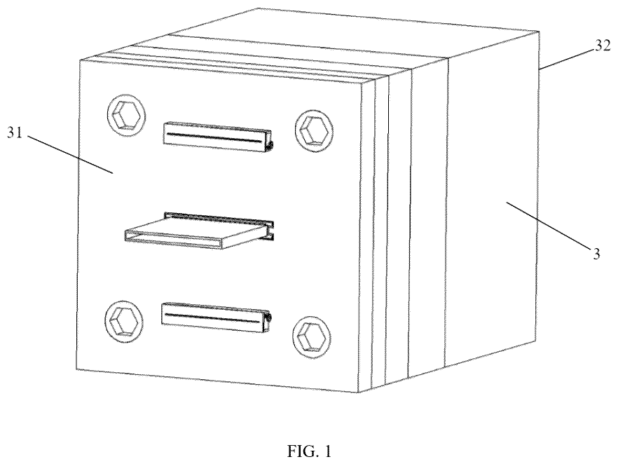

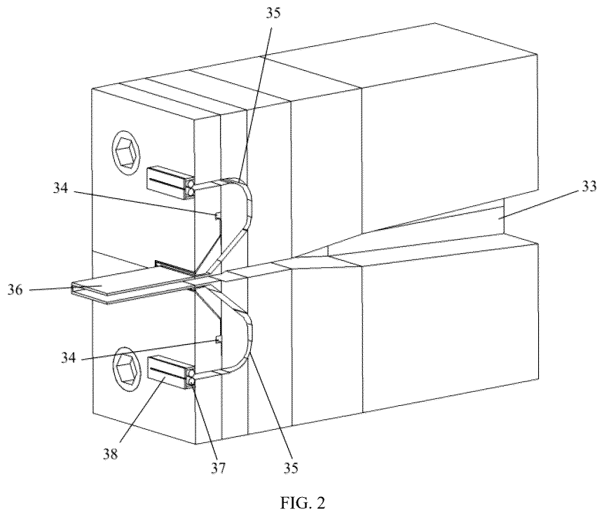

Referring to FIGS. 1 to 3, the embodiment of the present disclosure discloses a continuous fiber reinforced co-extrusion die, including a die body 3, where the front and rear end faces of the die body 3 are a mixing extrusion surface 31 and a core material feeding surface 32 respectively, and one side face of the die body 3 is provided with a shell material feeding inlet.

The die body 3 is provided thereinside with a core material supply channel 33 penetrating through the mixing extrusion surface 31 and the core material feeding surface 32. The core material supply channel 33 penetrates through one end of the mixing extrusion surface 31 to form a core material extrusion outlet 311.

The die body 3 is provided thereinside with a shell material supply cavity 34 surrounding the core material supply channel 33. One side of the shell material supply cavity 34 communicates with the shell material feeding inlet. The shell material supply cavity 34 extends toward the mixing extrusion surface 31 and penetrates through the mixing extrusion surface 31 to form a shell material extrusion outlet 312.

The die body 3 is provided thereinside with two fiber channels 35. The two fiber channels 35 are symmetrically arranged up and down, respectively. The fiber channels 35 are each an arc-shaped curved channel, and have both ends penetrating through the mixing extrusion surface 31. One ends of the two fiber channels 35 are opened to form fiber extrusion outlets 313, and are respectively located above and below the core material extrusion outlet 311 and located on the inner side of the shell material extrusion outlet 312. The other ends of the two fiber channels 35 are opened to form fiber extrusion inlets 314, and the two fiber extrusion inlets 314 are respectively located above and below the shell material extrusion outlet 312.

In order to further optimize the above technical solution, the edge of the core material extrusion outlet 311 extends in a direction away from the mixing extrusion surface 31 to form a core material temperature control extension cylinder 36.

Referring to FIG. 4, the outer side of the fiber extrusion inlet 314 is provided with a clamping roller assembly 37 mounted on the mixing extrusion surface 31. Specifically, in this embodiment, the clamping roller assembly 37 includes two mounting plates 371 fixed on the mixing extrusion surface 31, and two clamping rollers 372 are rotatably connected between the two mounting plates 371, and the gap between the two clamping rollers 372 corresponds to the fiber extrusion inlet 314.

In order to further optimize the above technical solution, the clamping roller assembly 37 has a one-way rotation limiting structure. In this embodiment, the one-way rotation limiting structure includes a ratchet 373 and a pawl 374. The ratchet 373 is installed at the end of one of the two clamping rollers 372. For convenient installation, the ratchet 373 is located on the outer side of the mounting plate 371. The pawl 374 is rotatably connected to the outer side of the mounting plate 371 through a torsion spring and is engaged with the ratchet teeth of the ratchet 373, so that the ratchet 373 may only rotate in one direction, thereby making the corresponding clamping roller 372 only rotate in one direction. When reverse rotation is required, it just needs to press the pawl 374 to make it disengaged from the ratchet teeth of the ratchet 373.

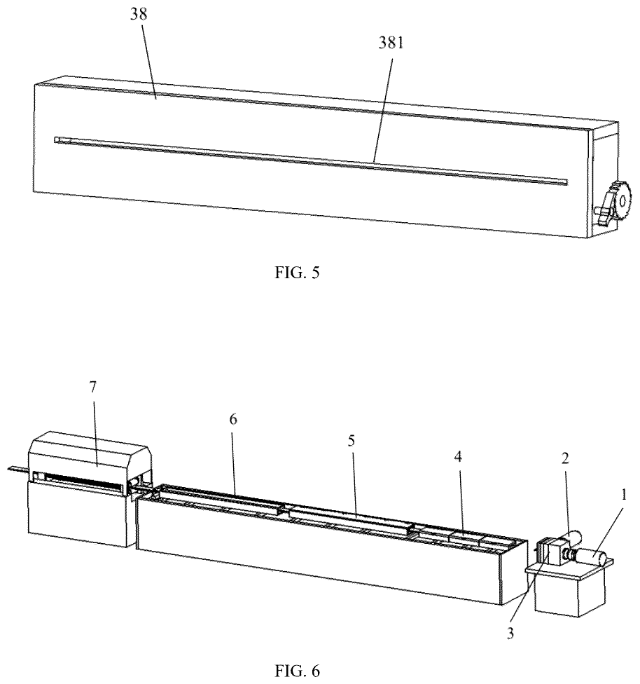

Referring to FIG. 5, a heater 38 is wrapped on the outer side of the clamping roller assembly 37. The heater 38 has a fiber inlet 381. In this embodiment, the heater 38 is of a shell structure, and may have various heating manners, such as electromagnetic heating, electric heating or thermal conductive oil heating.

In order to further optimize the above technical solution, the inner wall of the fiber channel 35 is coated with a Teflon coating.

In order to further optimize the above technical solution, the diameter of the core material supply channel 33 gradually decreases in a direction from the core material feeding surface 32 to the mixing extrusion surface 31.

In order to further optimize the above technical solution, the curved portion of the arc-shaped curved channel is rounded.

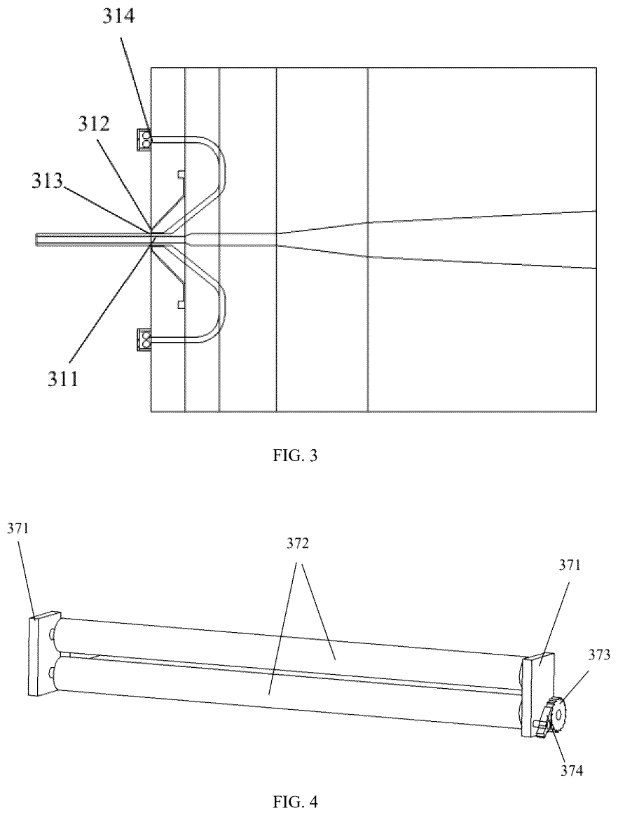

In this embodiment, the front end of the die body 3 is formed by assembling multiple die blocks through bolts, as shown in FIG. 3, which is aimed to facilitate the processing of the internal channel and make it easier to process and shape. In other words, it is only necessary to provide a channel or groove on each die block, and then perform combination, to form the complete channel structure.

### Embodiment 2

Referring to FIG. 6, the embodiment of the present disclosure discloses a molding line body, including the continuous fiber reinforced co-extrusion die of Embodiment 1, where a core material supply channel 33 of a core material feeding surface 32 of the die body 3 is connected to a core material extruder 1, and a shell material feeding inlet of the die body 3 is connected to a shell material extruder 2; and a shaping module 4, a vacuum water cooling group 5, an open water cooling group 6 and a traction machine 7 are sequentially arranged on a mixing extrusion surface 31 of t he die body 3.

In this embodiment, the forming process of the molding line body is as follows.

The core material extruder 1 and the shell material extruder 2 are fed with the same material, which is PVC material. The glass fiber is inserted from the fiber extrusion inlet 314, passes through the fiber channel 35, and then comes out from the fiber extrusion outlet 313. The core material is extruded from the core material extrusion outlet 311, and the shell material is extruded from the shell material extrusion outlet 312. In this way, the PVC material extruded from the core material extrusion outlet 311 and the shell material extrusion outlet 312 wraps the glass fibers coming out of the fiber extrusion outlet 313 thereinside, thereby forming a mixture to be foamed and shaped.

As shown in FIG. 6, in order to clearly show the structure, there is a certain distance between the die body 3 and the shaping module 4 in the figure. In the actual processing, the shaping module 4 is attached to the mixing extrusion surface 31 of the die body 3, and at the same time, the core material temperature control extension cylinder 36 is inserted into the cavity of the shaping module 4.

As shown in FIG. 7, the shaping module 4 includes a plurality of shaping molds 41. Each shaping mold 41 has a shaping cavity 41. The shaping cavity 411 may shape the mixture to be foamed and shaped which is extruded from the extrusion outlet. The shaping mold 41 may be opened and closed, and cold water is introduced into the inside of the shaping cavity 411 to cool and shape the mixture to be cooled and shaped, to form a floor body 8. The floor body 8 passing through the shaping module 4 enters the vacuum water cooling group 5.

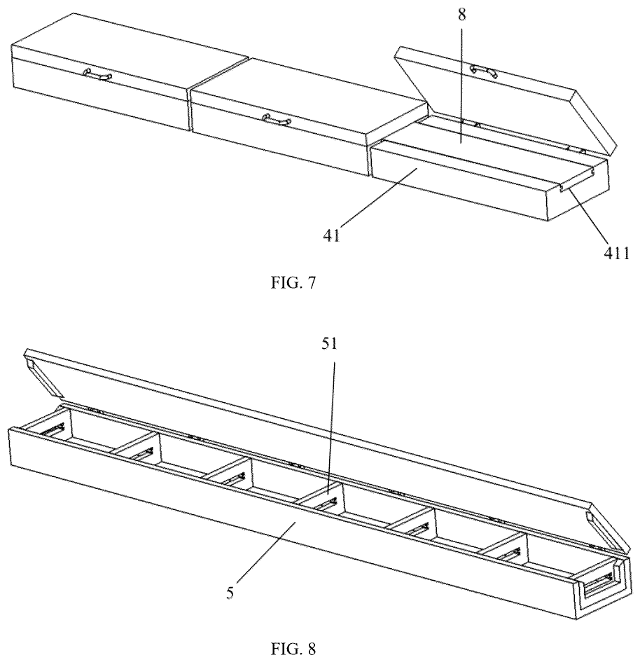

As shown in FIG. 8, the vacuum water cooling group 5 is an openable box body, and a plurality of guide frames 51 are fixed at intervals inside the openable box body. The floor body 8 passes through the guide frames 51, and the vacuum water cooling group 5 is vacuumed and cold water is introduced thereinto. The floor body 8 passing through the vacuum water cooling group 5 enters the open water cooling group 6.

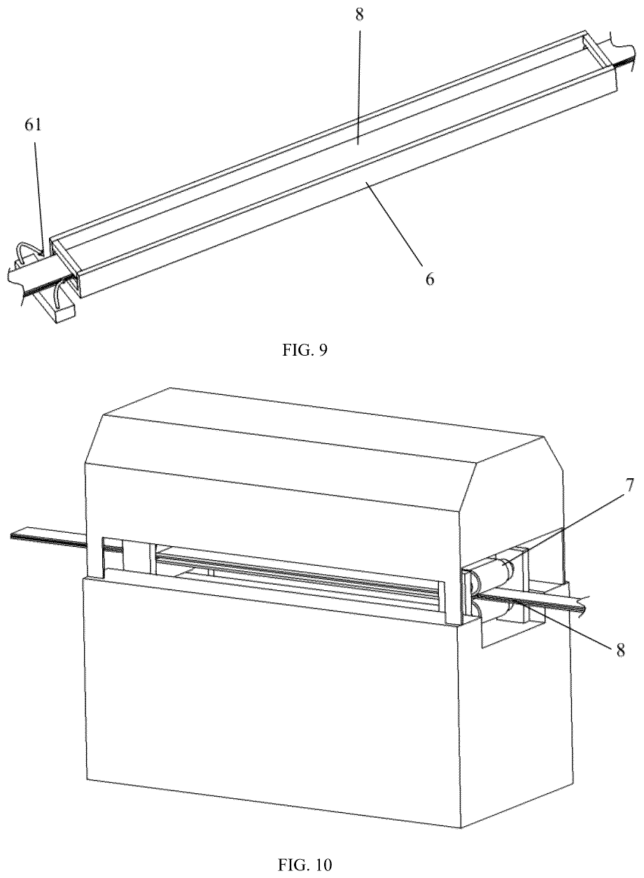

As shown in FIG. 9, the open water cooling group 6 is a box body with an open top. Cold water is introduced into the open water cooling group 6 and continuously flows out to be circulated. The end of the open water cooling group 6 is provided with a plurality of air nozzles 61, and the air nozzles 61 face the top surface of the floor body 8 and blow air in a direction toward the open water cooling group 6. The floor body 8 passing through the open water cooling group 6 enters the traction machine 7.

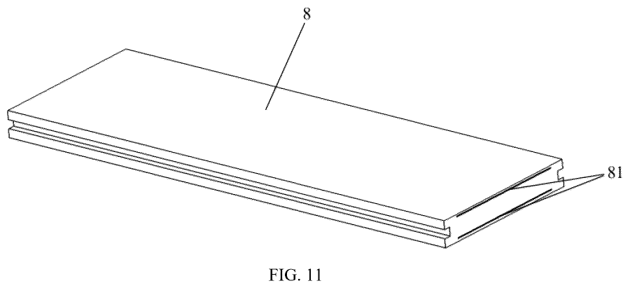

As shown in in FIG. 10, the traction machine 7 is of a double-layer crawler-belt-type structure, with crawler belts arranged up and down, and two layers of circulating crawler belts clamp the floor body 8 for traction/pulling.

It should be noted that when feeding the material at the beginning, the mixture to be foamed and shaped which is extruded from the extrusion outlet needs to be tied with a rope first, and this section is called the head material. Then the rope is stretched to the traction machine 7, and the rope is pulled by the traction machine 7 to stretch the head material. After the head material reaches the traction machine 7, the head material is cut off, and the shaped floor body 8 is clamped and pulled. For coordinated use, the guide frame 51 is of a structure formed by vertically alignment and combination. That is, after the head material passes through the shaping mold 41, the shaping mold 41 is closed, and after passing through the vacuum water cooling group 5, the guide frame 51 is assembled and the vacuum water cooling group 5 is closed.

It should be noted that the power of the extruder is not enough to push the mixed material to move forward, so it needs to be pulled by the traction machine 7. In actual processing, the pulling speed is set according to the thickness of the floor body 8: 0.6-1.2 m/min in general, 0.6 m/min for 22 mm thick board, and 0.8 m/min for 25 mm thick board.

The processed floor body 8 is as shown in FIG. 11. The floor body 8 has two fiber reinforced layers 81 thereinside which are arranged vertically. The fiber reinforced layer 81 is glass fiber in this embodiment.

In this specification, the embodiments are described in a progressive manner, and each embodiment focuses on the differences from other embodiments. The same or similar parts between the embodiments may be referred to each other. For the device disclosed in the embodiment, since it corresponds to the method disclosed in the embodiment, the description is relatively simple, and the relevant parts may be referred to the method parts.

The above description of the disclosed embodiments enables one skilled in the art to implement or use the present disclosure. Various modifications to these embodiments will be apparent to one skilled in the art, and the general principles defined herein may be implemented in other embodiments without departing from the spirit or scope of the present disclosure. Therefore, the present disclosure will not be limited to the embodiments shown herein, but rather will conform to the widest scope consistent with the principles and novel features disclosed herein.

1. A continuous fiber reinforced co-extrusion die, comprising a die body, wherein a front end face and a rear end face of the die body are respectively a mixing extrusion surface and a core material feeding surface, and one side face of the die body is provided with a shell material feeding inlet,
wherein the die body is provided thereinside with a core material supply channel penetrating through the mixing extrusion surface and the core material feeding surface, and the core material supply channel penetrates through one end of the mixing extrusion surface to form a core material extrusion outlet;
the die body is provided thereinside with a shell material supply cavity surrounding the core material supply channel, one side of the shell material supply cavity communicates with the shell material feeding inlet, and the shell material supply cavity extends toward the mixing extrusion surface and penetrates through the mixing extrusion surface to form a shell material extrusion outlet; and
the die body is provided thereinside with two fiber channels, and the two fiber channels are symmetrically arranged up and down respectively, each of the fiber channels is an arc-shaped curved channel, and has both ends penetrating through the mixing extrusion surface, one ends of the two fiber channels are open to form fiber extrusion outlets, and are located above and below the core material extrusion outlet respectively and located on an inner side of the shell material extrusion outlet, the other ends of the two fiber channels are open to form fiber extrusion inlets, and the two fiber extrusion inlets are located above and below the shell material extrusion outlet respectively.

2. The continuous fiber reinforced co-extrusion die according to claim 1, wherein an edge of the core material extrusion outlet extends in a direction away from the mixing extrusion surface to form a core material temperature control extension cylinder.

3. The continuous fiber reinforced co-extrusion die according to claim 1, wherein an outer side of the fiber extrusion inlet is provided with a clamping roller assembly installed on the mixing extrusion surface.

4. The continuous fiber reinforced co-extrusion die according to claim 3, wherein the clamping roller assembly has a one-way rotation limiting structure.

5. The continuous fiber reinforced co-extrusion die according to claim 3, wherein an outer side of the clamping roller assembly is wrapped with a heater, and the heater has a fiber inlet.

6. The continuous fiber reinforced co-extrusion die according to claim 1, wherein an inner wall of the fiber channel is coated with a Teflon coating.

7. The continuous fiber reinforced co-extrusion die according to claim 1, wherein a diameter of the core material supply channel gradually decreases in a direction from the core material feeding surface to the mixing extrusion surface.

8. The continuous fiber reinforced co-extrusion die according to claim 1, wherein a curved portion of the arc-shaped curved channel is rounded.

9. A molding line body, comprising the continuous fiber reinforced co-extrusion die according to claim 1, wherein the core material supply channel of the core material feeding surface of the die body is connected to a core material extruder, a shell material feeding inlet of the die body is connected to a shell material extruder, and a shaping module, a vacuum water cooling group, an open water cooling group and a traction machine are sequentially arranged on the mixing extrusion surface of the die body.

10. The molding line body according to claim 9, wherein an edge of the core material extrusion outlet extends in a direction away from the mixing extrusion surface to form a core material temperature control extension cylinder.

11. The molding line body according to claim 9, wherein an outer side of the fiber extrusion inlet is provided with a clamping roller assembly installed on the mixing extrusion surface.

12. The molding line body according to claim 11, wherein the clamping roller assembly has a one-way rotation limiting structure.

13. The molding line body according to claim 11, wherein an outer side of the clamping roller assembly is wrapped with a heater, and the heater has a fiber inlet.

14. The molding line body according to claim 9, wherein an inner wall of the fiber channel is coated with a Teflon coating.

15. The molding line body according to claim 9, wherein a diameter of the core material supply channel gradually decreases in a direction from the core material feeding surface to the mixing extrusion surface.

16. The molding line body according to claim 9, wherein a curved portion of the arc-shaped curved channel is rounded.

17. A fiber-reinforced foamed floor, comprising a floor body formed by processing by the molding line body according to claim 9, wherein the floor body is provided thereinside with two fiber reinforced layers arranged vertically.
